(19) United States
(12) Patent Application Publication
(10) Pub. No.: US 2008/0136629 A1
(43) Pub. Date: Jun. 12, 2008

(54) Wirelessly loaded speaking medicine container

(75) Inventor: Jerome R. Mahoney, Township of Colts Neck, NJ (US)

Correspondence Address: Deirdra M. Meagher;GlynnTech, Inc., 24 Mine Street, Flemington, NJ, 08822, US

(73) Assignee: ivoice, Inc.

(21) Appl. No.: 12/069,644

(22) Filed: Feb. 12, 2008

Related U.S. Application Data
(63) Continuation-in-part of application No. 10/768,930, filed on Jan. 30, 2004.

(51) Int. Cl. G08B 21/00

(52) U.S. Cl. 340/540

(57) ABSTRACT

The present method of communicating prescription medicine instructions or over-the-counter medicine instructions to patient, includes: (a.) providing at least one medicine container with a microprocessor, and, (b.) providing a central processor separate from the at least one medicine container. Each medicine container has the microprocessor attached to the medicine container. Each microprocessor includes: (a)(i) a wave file receiving chip; (a)(ii) a wave file storage means; (a)(iii) a wave file audio playback means; (a)(iv) an audio playback start means; and (a)(v) a power supply within the microprocessor. The central processor includes: (b)(i) user input means; (b)(ii) text-to-speech means; (b)(iii) wave file means to create a wave file from the text-to-speech means; and (b)(iv) wireless transmission means to transmit the wave file to the microprocessor wave file receiving chips of at least one container simultaneously. Wireless transmission may be radio frequency (RF) transmission systems, infrared (IR) transmission systems and any other wireless transmission systems that are now available or may become available. There is compliant warning feature when the tablets remaining does not match a number over a calculated tablets that should remain.

### REFERENCE TO RELATED APPLICATION

This is a continuation-in-part of copending U.S. patent application Ser. No. 10/768,930 filed on entitled “Wirelessly Loaded Speaking Medicine Container” by the same inventor herein.

### BACKGROUND OF THE INVENTION

1. Field of the Invention

The present invention relates to speaking medicine containers, and, more particularly, first creating prescription or over the counter medicine instructions in a central computer, wirelessly transmitting those instructions to at least one medicine container, and storing them for subsequent audio playback by a user. Thus, the present invention relates to both the method of performing these steps, and the combination of devices and software (the system) for doing this.

2. Information Disclosure Statement

The following prior art is representative of the state of the art in the field of pertinent medicine containers or the art pertaining to wireless communications:

U.S. Pat. No. 7,002,476 B2 describes a method and apparatus for facilitating compliance with a medication regimen by a user. The method includes the steps of providing the user with a medication dispensing unit for dispensing medication to the user and a wireless transceiver operatively coupled to a controller of the medication dispensing unit from a server to the controller of the medication dispensing unit through the wireless transceiver and downloading a set of instructions that instruct the user on how to use the dispensed medication through the wireless transceiver to the user.

U.S. Pat. No. 6,563,911 B2 describes the present invention a speech enabled automatic telephone dialer device, system, and method using a spoken name corresponding to name-telephone number data of computer-based address book programs. The invention includes user telephones connected to a PBX-type telephony mechanism, which is connected to a telephony board of a name dialer device. User computer workstations containing loaded address book programs with name-telephone number data are connected to the name dialer device. The name dialer device includes a host computer in a network; a telephony board for controlling the PBX for dialing; a memory within the host computer for storing software and name-telephone number data; and, software to access computer-based address book programs, to receive voice inputs from the PBX-type telephony mechanism, to create converted phonemes from names to match voice inputs with specific name-telephone number data from the computer-based address book programs for initiating an automatic dialing.

U.S. Pat. No. 6,463,462 B1 describes an automated system for delivery of messages to multiple recipients, and for processing of responses to the messages, includes a message client, message server, and system database. A message is created using universal message form. The message content can be translated in to multiple formats and sent to one or more different recipients using one or more different types of messaging devices, including pagers, telephones, fax machines, and e-mail readers. A recipient profile manager allows each recipient to select the messaging devices to be used for message delivery as well as preferred messaging schedules, priorities, and messages security. Receipt of the messages by the recipients is verified, response requirements collected and consolidated from multiple sources and presented to the message originator in structured format.

U.S. Pat. No. 6,394,278 B1 describes a system and method for assisting an operator in sorting mail includes a wireless headset equipped with a microphone, and a workstation that includes a processing unit, voice-recognition and voice-synthesis circuitry, and a database. In operation, addressee information spoken into the microphone is transmitted to the work station where it is used to search the database. Destination information from a matching database record is then output to the operator on one or more of a display terminal, head set speakers, and heads-up display fixed to the head-set. The convenience and enhanced capability provided by this system steaminess operator productivity and sorting volume. The embodiments disclosed herein are primarily directed to a headset that is operated completely remotely from the processing unit, and also to a head set comprising a heads up display having means by which an operator can access the database.

U.S. Pat. No. 6,380,858 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various informations about medicament contained within a respective container. A Smart Tray is equipped with a processor and reader that interrogates each respective electromagnetic tag to identify medicament(s) contained within each container. Using the retrieved information, a Smart Tray provided visual and/or audio signals to a patient to remind the patient when and how much of various medicaments to take. A Smart Tray also monitors, via the reader, when a mediation container is removed. A Smart Tray can communicate with one or more third parties, such as healthcare products and services via a computer network. In addition, a Smart Tray can communicate with various appliances and can modify medication regimens for particular medicaments in response to data received from various appliances.

U.S. Pat. No. 6,294,999 B1 describes systems and methods that are provided for facilitating effective self-management of medication treatment by patients. A Smart Tray monitors and reports to third parties a patient's compliance with various medication treatment regimens. Medication containers are provided with electromagnetic tags that provide various informations about medicament contained within respective container. A Smart Tray is equipped with a processor and reader that interrogates each respective electromagnetic tag to identify medicament(s) contained within each container. Using the retrieved information, a Smart Tray provides visual and/or audio signals to a patient to remind the patient when and how many of various medicaments to take. A Smart Tray also monitors, via the reader, when a medication container is removed. A Smart Tray can communicate with one of more third parties, such as healthcare providers, pharmacies, and other suppliers of healthcare products and services via a computer network. In addition, a Smart Tray can communicate with various appliances and can modify medication regimens for particular medicaments in response to data received from various appliances.

U.S. Pat. No. 6,150,942 describes an interactive prescription compliance, and life safety system that provides remote and on site verification of procedures related to the health status of a person, including taking of medicines, responsiveness to queries, and attendance of health care and service providers in the home by providing for signals to and from a person's location, with alarm activation when a deviation from a preprogrammed procedure occurs.

U.S. Pat. No. 6,032,155 describes an invention that related to a method and apparatus for administering prescribed medication to a patient. The prescribed medication administration system and apparatus dispense prescribed medication, verify the medication is given to a correct patient by and authorized healthcare worker and tracks and records the administration of the medication. The system utilizes a workstation connected to a database containing prescribed medication dose information for various patients. A healthcare worker uses the workstation to manually or automatically dispenses the medication the portable container. An information device is secured to the portable container during transport and administration of the medication to the intended patient. The information device prevents access to the medication or warns the healthcare worker of a potential error if the medication is delivered to the wrong patient or administered by an unauthorized healthcare worker. The information device records actual consumption information, and delivers this information back the workstation database or to a hospital or pharmacy database.

U.S. Pat. No. 6,021,433 describes a system and method for data communication connection on-line networks with on-line computers. The present system provides for broadcast of up to the minute notification centric data there by providing an instant call to action for users who are provided with the ability to instantaneously retrieve further detailed information. Information sources transmit data to a central broadcast server, which preprocesses the data for wireless broadcast. The notification centric portions of data are wirelessly broadcast to wireless receiving devices that are attached to computing devices. Upon receipt of the dada the computing device, the user is notified through different multimedia alerts that there is an incoming message. Wirelessly broadcasted URL's, associated with the data, are embedded in data packets and provide an automated wired or wireless connection back to the information source for obtaining detailed data.

U.S. Pat. No. 6,018,289 describes a prescription compliance device which aids patients in complying with instructions given by a physician for taking prescription medication. The device reminds a patient when the next dose of medication is to be taken and indicates whether a specified dose has been taken. The device includes a microcontroller, a display, a program memory for storing pre-programmed medication-taking regimens and for programming the device as to the time and day on which the first dose of medication is to be taken, a display which alternately displays the current time and a time at which a next dose of medication is to be taken, and an alarm which alerts the patient at times when a dose of medication is to be taken. The selector includes an event switch, which is activated by the patient after taking a dose of medication so as to record the taking of the medication and to cause the microcontroller to effect the display of the next time at which a dose of medication is to be taken. A memory may also be included to record the times at which a patient takes doses of medication. The device is small enough to be attached to medication containers, and includes a remote programming feature via a wireless link.

U.S. Pat. No. 5,917,429 describes a means which digital data are communicated between a portable data-gathering unit and a date-receiving unit without direct electrical connection by transmitting the data over a contactless connection system. In a preferred embodiment, data flow is bidirectional.

U.S. Pat. No. 5,846,089 describes a medicine container that provides audible dosage instructions in a voice recognizable to the user, so that the user, even with a sight or like disability, can rely on voice recognition as providing verification of the accuracy and particular appropriateness of the dosage instructions to the user of the medicine container.

U.S. Pat. No. 5,835,455 describes a reprogrammable device for removably receiving a medicine container and for providing audio instructions to a patient for taking a medication. When a medicine container is removed from the device by the patient so that the patient may take the medicine, the device can be activated to play a pre-recorded individualized message from the pharmacist providing the patient audio instructions for taking the medication.

U.S. Pat. No. 5,774,865 describes the patient compliance and monitoring device that utilizes a tray with a base for holding medicine containers such as bottles. Inside the base attached to the tray in a weight scale connected to a computer. Also connected to the computer are an alphanumeric keyboard and an LCD monitor which attached to the base. The computer entails a microprocessor connected to ROM and RAM and encoded with instruction sets to determine the dosage taken by a user as well as the date and time taken. The medicine containers are detected, preferably, by a bar code reader inside the base scanning bar code labels attached to the bottom of the medicine containers.

U.S. Pat. No. 5,014,798 describes a present invention that is directed to a cap for a medicine bottle for monitoring a patient's medicine compliance. In involves weighing a container of medicine with cap with includes scale means located therein which is connected to a computer chip with a display unit also located in or on the cap. The chip may store the starting weight or tare weight, plus total weight and when the container or medicine is picked up by the cap at any time, actual weight is fed to the chip. The computer chip may they determine the difference between the starting weight and/or display actual amount of medicine remaining or consumed. The container of medicine is reweighed from time to time with the cap and then chip may compare actual weight with compliance required weight to determine compliance and the cap may visually display the compliance results on the display unit to inform the patient. An optional audio assist may direct the patient to “call the doctor” if a significant compliance deviation is recognized. United States Patent Application Publication US2006/0116780 A1 describes a digital audio recording and reproducing apparatus, an analog audio signal supplied from a microphone is converted into digital audio data, and after compressing the digital audio data such that the analog audio signal is converted into digital data, compressed digital audio data is stored in an internal solid state memory and/or external solid state memory as data file having a file format which can be directly treated by an external computer. Decompressed digital audio data is converted into an analog audio signal. Thus, converted analog audio signal is reproduced by a speaker or earphone.

United States Patent Application Publication US2003/0156724 A1 describes an audio instruction system which includes a pill container, a sound player, an activating member and a locator. The sound player is operatively engaged to the pill container. The activating member is operatively engaged to the pill container to activate the sound player. The locator is positioned relative to the pill container and the activating member to aid a user to locate the activating member.

United States Patent Application Publication US2003/0014252 A1 describes a setting window that is displayed when a mail tab is selected includes check boxes for selecting items to read when an electronic mail is read. And boxes for setting automatic checking of electronic mails. Contents corresponding to checked boxes among the check boxes except for the body of the electronic mail, are used for generating a title to be added when the speech data is output to an external apparatus. If none of the check boxes is checked a predetermined character string is set as a title.

Notwithstanding the prior art, the present invention is neither taught nor rendered obvious thereby.

### SUMMARY OF THE INVENTION

The present invention relates to a method of communicating prescription medicine instructions or over-the-counter medicine instructions to patient, this method includes: (a.) providing at least one medicine container with a microprocessor, and, (b.) providing a central processor separate from the at least one medicine container. Each at least one medicine container includes a storage area for medicine and some type of closure, e.g., a cap, and has the microprocessor attached to the medicine container. The microprocessor includes: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor. In addition, the microprocessor may include a compliant warning feature based upon total tablets when filled, required consumption of tablets, and day elapsed. Based upon a predetermined number of tablets remaining message, a patient is advised to see a professional.

The central processor includes: (b)(i) user input means; (b)(ii) text-to-speech means; (b)(iii) wave file means to create a wave file from the text-to-speech means; and (b)(iv) wireless transmission means to wirelessly transmit the wave file from the central processor to the microprocessor wave file receiving chip. The phrase “wireless transmission means” shall include radio frequency (RF) transmission systems, infrared (IR) transmission systems and any other wireless transmission systems that are now available or may become available for a transmission of data over airwaves.

The method further includes: (c.) inputting the user input means to create medicine instruction text; (d.) converting the text to electronic speech; (e.) creating a wave file with the electronic speech; (f.) transmitting the wave file to the microprocessor wave file receiving chip; and (g.) storing the wave file for subsequent playback by a user by activating the audio playback starting means.

In some preferred embodiments, the present invention method central processor is a computer system and the user input means is a conventional computer user input means selected from keyboard, mouse, ball and touch pad.

In other preferred embodiments of the present invention method, the following steps are: (h.) creating a unique identifier in the central processor; (i.) transmitting the unique identifier to the microprocessor; and j.) providing accessing means for accessing the unique identifier from the microprocessor.

When there is one medicine container, the medicine instructions are for prescription medicine, in which the microprocessor further includes a compliant warning feature having an internal clock, total medicine container starting tablet count, required tablet consumption rate data, and programming. The internal clock is started when a patient activates the audio playback start means for a first time. When a user subsequently activates the audio playback start means at a later time, the microprocessor plays back a regimen message advising the user that a predetermined number of tablets should be remaining in the medicine container at this time, and if that predetermined number of tablets remaining is in excess by a predetermined amount, that patient is advised to contact a professional. The microprocessor calculates current tablet count based upon the first activation, the total starting tablet count, and the tablet consumption rate data.

When there is a plurality of medicine containers for over-the-counter medicine, the medicine instructions are for over-the-counter medicine and are communicated to a plurality of patients utilizing same medicine and dosage. The method further comprises providing a plurality of medicine units to the storage area of each of the plurality of medicine containers. The plurality of medicine units are the same medicine and have the same dosage for each of the plurality of medicine containers.

The microprocessor may be attached to a bottom of each of the medicine container, to a top of each of the medicine container, to a wall of each of the medicine container or to a cap or other closure.

In some embodiments, the user input means is a microphone and the central processor includes conversion means for converting speech to electronic input.

An alternative embodiment present invention method of communicating prescription or over-the-counter medicine instructions to a patient includes: (a.) providing at least one medicine container, each of the at least one medicine container including a storage area for medicine, and a microprocessor attached to each medicine container. The microprocessor includes: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor; and (b.) providing a central processor separate from the medicine container. In addition, the microprocessor may include a compliant warning feature based upon total tablets when filled, required consumption of tablets, and day elapsed. Based upon a predetermined number of tablets remaining message, a patient is advised to see a professional.

The central processor includes: (b)(i) user input means for inputting electronic medicine instruction input; (b)(ii) wave file means to create a wave file from the electronic medicine instruction input from the input means; and (b)(iii) wireless transmission means to wirelessly transmit the wave file from the central processor to the microprocessor wave file receiving chip. This alternative method also includes the steps of: (c.) inputting medicine instructions with the user input means to create electronic input; (d.) creating a wave file with the electronic input; (e.) transmitting the wave file to the microprocessor wave file receiving chip; (f.) storing the transmitted wave file for subsequent audio playback by a user by activating the audio playback starting means.

The present invention also relates to a system (combination of equipment and software) for communicating medicine instructions to a patient by wireless communication from a central processor to a medicine container for subsequent audio speech playback from the medicine container to a user. The system includes: (a.) at least one medicine container, each medicine container including a storage area for medicine, and a microprocessor attached to each medicine container, the microprocessor including: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor; and (b.) a central processor separate from the medicine container, the central processor including: (b)(I) user input means; (b)(ii) text-to-speech means; (b)(iii) wave file means to create a wave file from the text-to-speech means; and (b)(iv) wireless transmission means to wirelessly transmit the wave file from the central processor to the microprocessor wave file receiving chip.

An alternative embodiment present invention system for communicating medicine instructions to a patient by wireless communication from a central processor to a medicine container for subsequence audio speech playback from the medicine container to a user, includes: (a.) a medicine container including a storage area for medicine, and a microprocessor attached to the medicine container, the processor including: (a)(i) a wave file receiving chip; (a)(ii) a wave file storage means; (a)(iii) a wave file audio playback means; (a)(iv) an audio playback start means; and (a)(v) a power supply within the microprocessor, and adapted to power components of the microprocessor it also includes; (b.) a central processor separate from the medicine. In addition, the microprocessor may include a compliant warning feature based upon total tablets when filled, required consumption of tablets, and day elapsed. Based upon a predetermined number of tablets remaining message, a patient is advised to see a professional.

The central processor includes: (b)(i) user input means said electronic medicine instrument input (b)(ii) wave file means to create a wave file from the text-to-speech means; and (b)(iii) wireless transmission means to transmit the wave file from the central processor to the microprocessor wave file receiving chip.

These systems may be computer systems, and the user input means may be a conventional computer user input means selected from keyboard, mouse, ball and touch pad.

The systems may optionally include: (h.) means for creating a central processor unique identifier in the central processor; (i.) means for transmitting said unique identifier to the microprocessor; and (j.) providing accessing means for accessing the central processor unique identifier from the microprocessor.

The systems may be system wherein the user input means is a microphone and the central processor included reversion means for converting speech to electronic input.

### BRIEF DESCRIPTION OF THE DRAWINGS

The present invention should be more fully understood when the specification herein is taken in conjunction with the drawings appended hereto wherein:

FIG. 1 illustrates a schematic diagram of one preferred embodiment of the present invention method and system for prescription medicine;

FIG. 2 shows another schematic diagram of an alternative embodiment of a present invention method and system for prescription medicine;

FIG. 3 shows a diagrammatic representation of a present invention system for prescription medicine;

FIG. 4 illustrates another preferred embodiment of the present invention method and system for wirelessly transferring prescription medicine instructions from a central processor to a medicine container for subsequent audio playback by a user;

FIG. 5 illustrates a schematic diagram of another preferred embodiment of the present invention method and system for over-the-counter medicine;

FIG. 6 shows another schematic diagram of an alternative embodiment of a present invention method and system for over-the-counter medicine;

FIG. 7 shows a diagrammatic representation of a present invention system for over-the-counter medicine;

FIG. 8 illustrates another preferred embodiment of the present invention method and system for wirelessly transferring over-the-counter medicine instructions from a central processor to a medicine container for subsequent audio playback by a user;

FIG. 9 illustrates a schematic diagram of one preferred embodiment of the present invention method and system for prescription medicine including a compliant warning feature;

FIG. 10 shows another schematic diagram of an alternative embodiment of a present invention method and system for prescription medicine including a compliant warning feature;

FIG. 11 illustrates another preferred embodiment of the present invention method and system for wirelessly transferring prescription medicine instructions from a central processor to a medicine container for subsequent audio playback by a user including a compliant warning feature; and,

FIG. 12 illustrates a schematic diagram of the compliant warning feature shown in FIGS. 9, 10 and 11.

### DETAILED DESCRIPTION OF THE PRESENT INVENTION

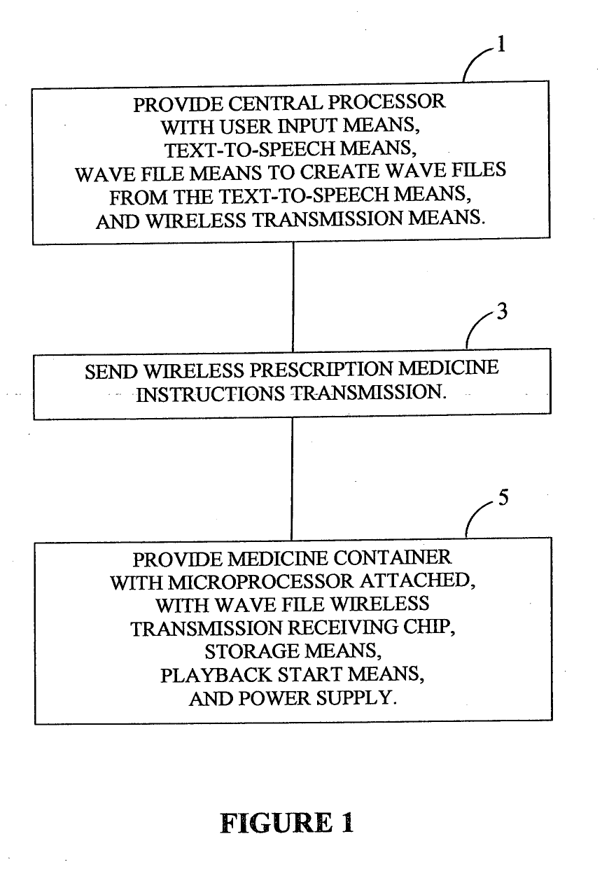

FIG. 1 illustrates a schematic diagram of one preferred embodiment of the present invention method and system for prescription medicine. In FIG. 1, central processor 1 may be any type of central processor that is available and is capable of supporting the necessary hard were and soft were to perform the functions described herein. Thus, the central processor 1 could be a collection of intranet connected units, a server, a stand alone computer, a PC, a notebook, a lap top or even a multimedia system or handheld computer, or a device that includes a computer.

Central processor 1 requires user input means and this could be any available user means, but is typically a ball, a mouse, a key pad, a microphone, or combinations of these. It also includes text-to-speech means and these are well known systems that convert electronic text to speech. These are well known programs and wold be familiar to one of ordinary skill in this art. For example, U.S. Pat. No. 6,394,278 B1 and patents cited therein show speech-to-text and text-to-speech capabilities.

Central processor 1 also includes wave file means to create wave files from the text-to-speech means, as well as wireless transmission means. Wave files creation and wireless transmission, not in the present invention system, are known to the artisan and are described in the cited prior above.

The user will use the input means to create the wave files by normal input of prescription medicine instructions, and these are wirelessly transmitted 3 to medicine container 5.

Medicine container 5 includes a microprocessor attached to it that receives the wave file wireless transmission, storage means for storing the wave file and whatever additional software that may be required to create audible speech patterns. Medicine container 5 also includes play back and play back start means as well as a power supply. Typically, the microprocessor would be located on the bottom of the medicine container and would be cylindrical or otherwise conformed to the general shape of the medicine container. Alternatively, it could have any convenient shape and be located on any aria of the medicine container or its cap. It would include a start mechanism that could be a button or switch, or its equivalent. A user would simply activate the start mechanism and the microprocessor would automatically play back the prescription instructions.

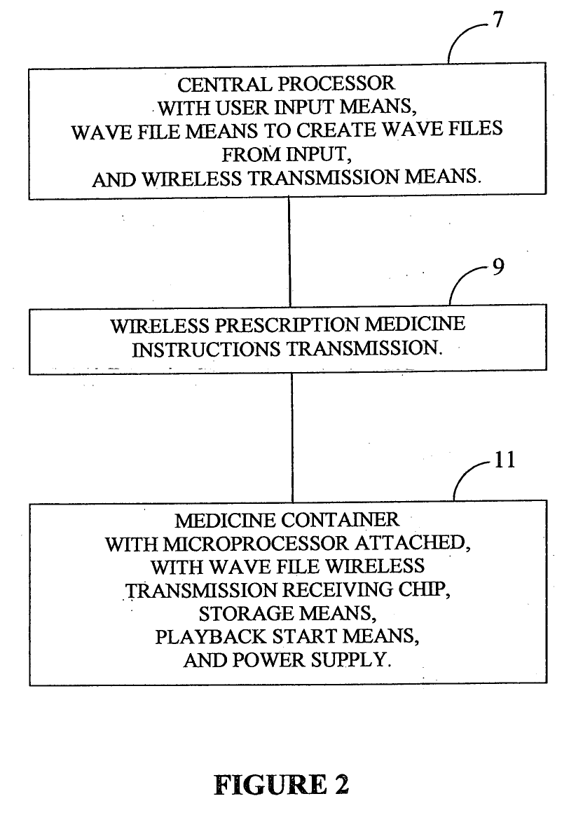

FIG. 2 shows another schematic diagram of an alternative embodiment of a present invention method and system for prescription medicine. In this embodiment, the central processor 7 functions similarity to central processor 1 above but creates wave files directly from inputs and transmits 9 these to container 11. Medicine container 11 functions similarity to medicine container 5 of FIG. 1.

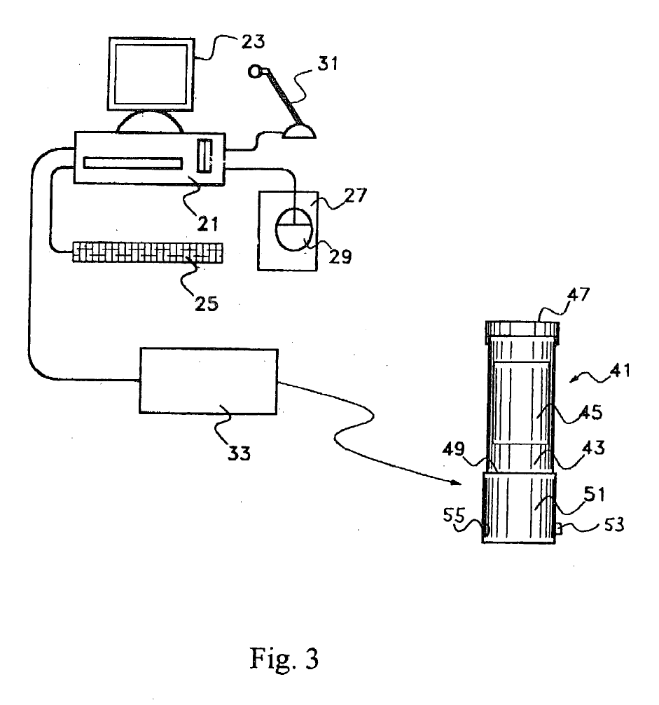

FIG. 3 shows a diagrammatic representation of a present invention system for prescription medicine. There is a central processor, in this case, computer 21 with monitor 23, as well as impute means which, in this embodiment, are shown to be keyboard 25, mouse 27 and pad 29 and microphone 31. A slider, joystick, or touch ball, or any other input means could be included in addition to or in place of those shown in the figure.

Computer 21 could be a master server, a personal computer, or any other type of computer. Computer 21 is connected to transmitter 33 for short distance transmission of the wave file. While this is shown as a separate device wired to computer 21, it could be built in to a computer unit with appropriate hardware, software and middleware. This wirelessly transmits the wave file package with optional unique identifier information to medicine container 41, and, more particularly to its microprocessor 51 attached to container bottom 49. Container 41 includes a typical medicine storage 43, a label 45 and a cap 47. Playback start button 53 enables a user to playback the received and stored wave file packet prescription medicine instruction as often as desired.

Microprocessor 51 includes a wave file wireless transmission receiving chip and a power supply, as well as storage means and optional unique identifier retrieval means. This could be a plug in port such as port 55

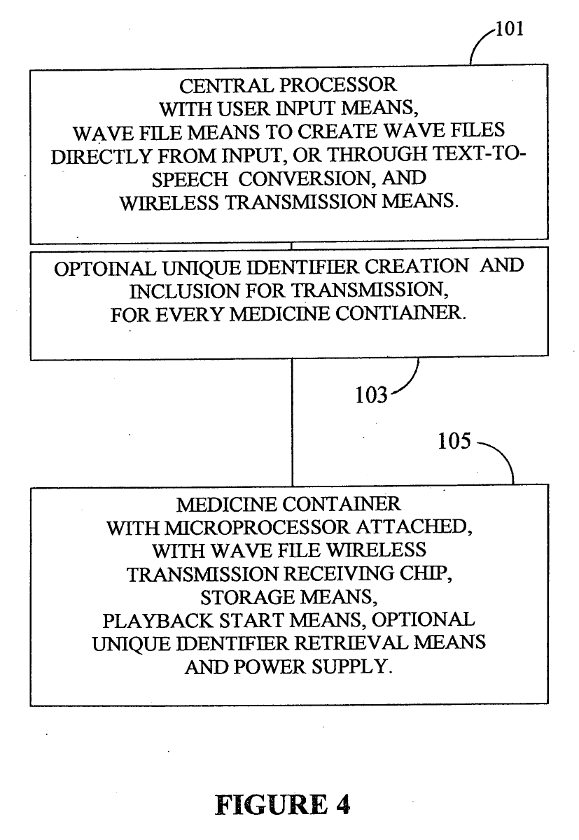

FIG. 4 illustrates another preferred embodiment of the present invention system for wirelessly transferring prescription medicine instructions from a central processor to a medicine container for subsequent audio playback by a user. Central processor 101 may be arranged as in FIG. 1 or as in FIG. 2 above, and, includes optional unique identifier capabilities 103. This includes sufficient equipment and software to create a unique identification code for each and every medicine container to which a wave file is sent. This code could be any combination of numbers and/or letters and/or symbols.

In one preferred embodiment of the present invention for prescription medicine, the system is provided to a pharmacist or similar functionary, who inputs the appropriate prescription medicine instruction for creation wave file, and transmission to the receiving medicine container microprocessor. A number of variations are possible. For example, the wave file may include a unique identifier along with other information, such as the patients name, the doctor name, date and/or pharmacy name.

In one preferred embodiment for prescription medicine, the software is set up to present queries or blanks for the pharmacist, asking for patient and product information, date, etc. and will provide a location for specific instructions. This software program will create records for the pharmacist, print out a label for the medicine container and create a wave file, with requiring only a single set of inputs. The unique identifier may include date and pharmacy location information, patient information and unique characters for each particular medicine container.

In another embodiment for prescription medicine, the software program of the central processor may contain list of various pharmaceutical products with different dosages so that a pharmacist may click a specific product and dosage, and a specific set of prescription instructions will appear. The pharmacist will click to confirm and this will be inserted in to a file for addition patient and other input. A preexisting wave file corresponding to that selection by the pharmacist will be automatically brought up and wirelessly transmitted to the medicine container microprocessor when the pharmacist clicks a send directive.

In yet other embodiments of the present invention for prescription medicine, the pharmacist central processor could be connected to the internet so as to connect with a particular internet site that would provide dosage information and even wave file packets from individual pharma companies, or a separate clearing house service that would include information from many or all major pharma companies.

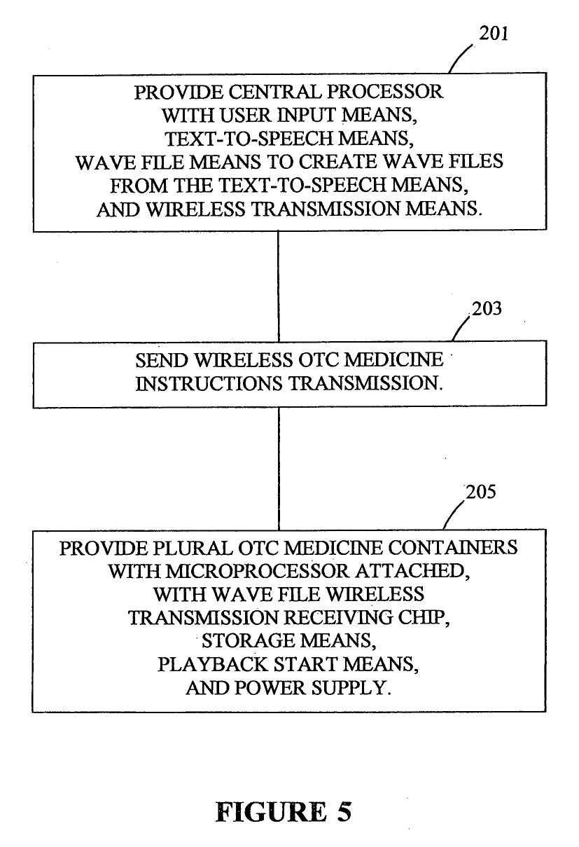

FIG. 5 illustrates a schematic diagram of one preferred embodiment of the present invention method and system for over-the-counter medicine. In FIG. 5, central processor 201 may be any type of central processor that is available and is capable of supporting the necessary hardware and software to perform the functions described herein. Thus, the central processor 201 could be a collection of internet or intranet connected units, a server, a stand alone computer, a PC, a notebook, a lap top or even a multimedia system or handheld computer, or a device that includes a computer.

Central processor 201 requires user input means and this could be any available user means, but is typically a ball, a mouse, a key pad, a microphone, or combinations of these. It also includes text-to-speech means and these are well known systems that convert electronic text to speech. These are well known programs and would be familiar to one of ordinary skill in this art. For example, U.S. Pat. No. 6,394,278 B1 and patents cited therein show speech-to-text and text-to-speech capabilities.

Central processor 201 also includes wave file means to create wave files from the text-to-speech means, as well as wireless transmission means. Wave files creation and wireless transmission, not in the present invention system, are known to the artisan and are described in the cited prior above.

The user will use the input means to create the wave files by normal input of OTC medicine instructions, and these are wirelessly transmitted 203 to a plurality of medicine containers 205. These may be done in batches, sequentially, simultaneously, or in group/step functions. Typically, these are hundreds or thousands or millions of containers with the same over-the-counter medicine at the same dosage.

Each medicine container 205 includes a microprocessor attached to it that receives the wave file wireless transmission, storage means for storing the wave file and whatever additional software that may be required to create audible speech patterns. Each of the plurality of medicine containers 205 also include playback and playback start means as well as a power supply. Typically, the microprocessors would be located on the bottom of the medicine containers and would be cylindrical or otherwise conformed to the general shape of the medicine container. Alternatively, it could have any convenient shape and be located on any area of the medicine container or its cap. It would include a start mechanism that could be a button or switch, or its equivalent. A user would simply activate the start mechanism and the microprocessor would automatically playback the OTC instructions.

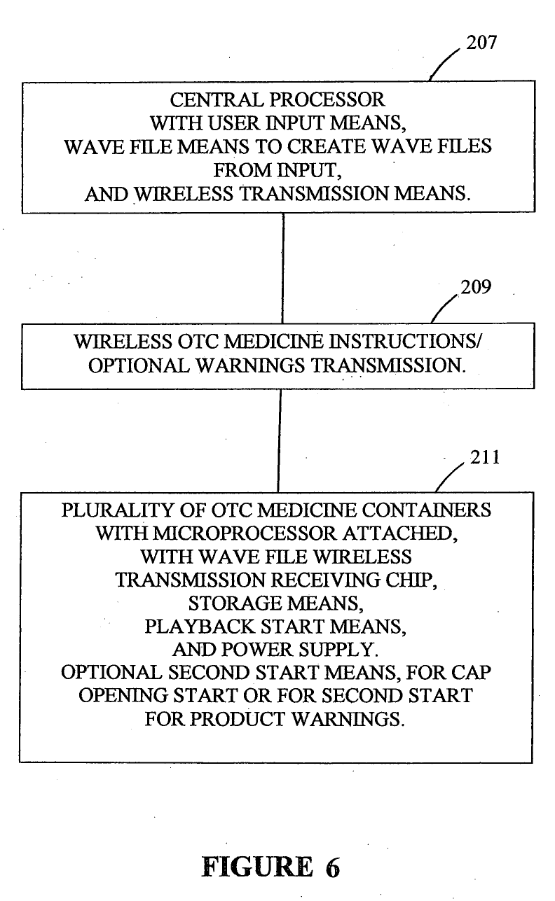

FIG. 6 shows another schematic diagram of an alternative embodiment of a present invention method and system for over-the-counter medicine. In this embodiment, the central processor 207 functions similarity to central processor 201 above but creates wave files directly from inputs and transmits 209 these to a plurality of OTC medicine containers 211. Medicine containers 211 function similarity to medicine containers 205 of FIG. 5, except that an optional second start means is included on the medicine containers with, for example, dual microprocessor capabilities. This could be a cap-connected second start mechanism that would automatically play the first time the cap is removed, or it could be a second start mechanism for playing product warnings.

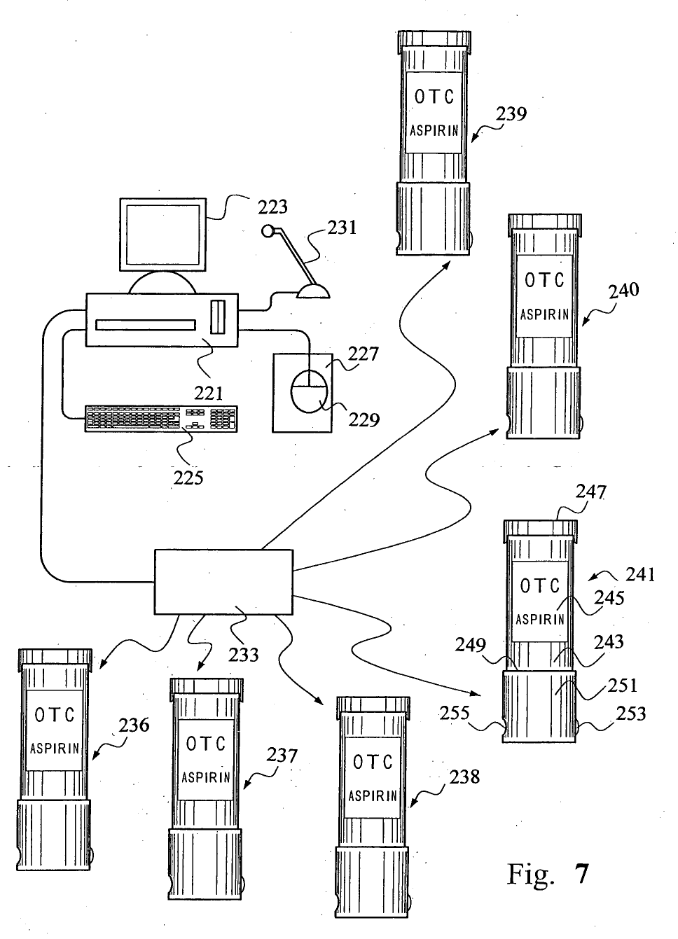

FIG. 7 shows a diagrammatic representation of a present invention system for over-the-counter medicine. There is a central processor, in this case, computer 221 with monitor 223, as well as impute means which, in this embodiment, are shown to be keyboard 225, mouse 227 and pad 229 and microphone 231. A slider, joystick, or touch ball, or any other input means could be included in addition to or in place of those shown in the figure.

Computer 221 could be a master server, a personal computer, or any other type of computer. Computer 221 is connected to transmitter 233 for short distance transmission of the wave file. While this is shown as a separate device wired to computer 221, it could be built in to a computer unit with appropriate hardware, software and middleware. This wirelessly transmits the wave file package with optional unique identifier information to a plurality of OTC medicine containers 236, 237, 238, 239, 240, and 241, and, more particularly to their microprocessors. Details are shown with respect to container 241, which includes microprocessor 251 attached to container bottom 249. Container 241 includes a typical medicine storage area 243, a label 245 and a cap 247. Playback start button 253 enables a user to playback the received and stored wave file packet OTC medicine instruction as often as desired.

Microprocessor 251 includes a wave file wireless transmission receiving chip and a power supply, as well as storage means and optional unique identifier retrieval means. This could be a plug in port such as port 255.

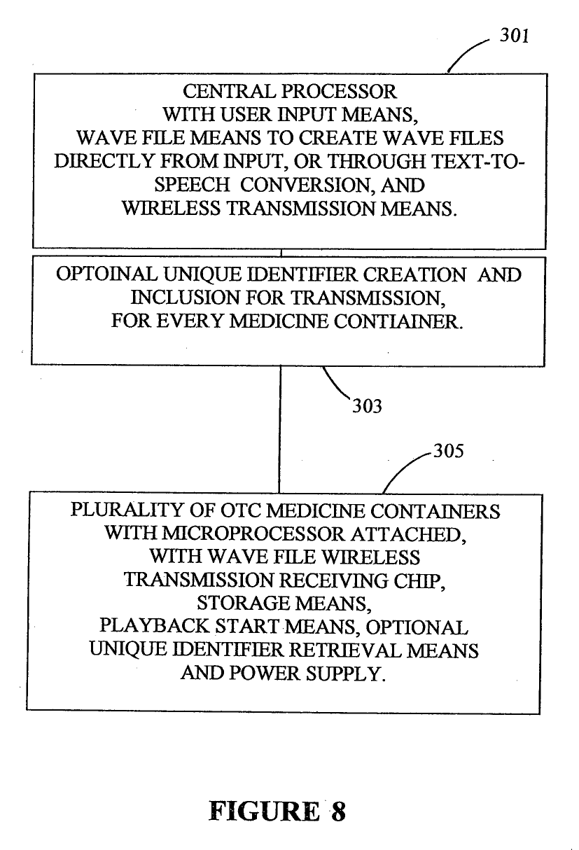

FIG. 8 illustrates another preferred embodiment of the present invention system for wirelessly transferring OTC medicine instructions from a central processor to a medicine container for subsequent audio playback by a user. Central processor 301 may be arranged as in FIG. 5 or as in FIG. 6 above, and, includes optional unique identifier capabilities 303. This includes sufficient equipment and software to create a unique identification code for each and every medicine container to which a wave file is sent. This code could be any combination of numbers and/or letters and/or symbols.

In one preferred embodiment of the present invention for over-the-counter medicine, the system is provided to a pharmaceutical manufacturer operator or similar functionary, may input the appropriate OTC medicine instruction for creation wave file, for subsequent transmission to the receiving medicine container microprocessors. A number of variations are possible. For example, the wave file may include a unique identifier along with other information, such as the manufacturers names, the contents of the container, product codes, bar code equivalents, etc.

In one preferred embodiment for over-the-counter medicine, the software is set up to create records for the manufacturer, such as batch numbers, processing dates, and even print out a labels for the medicine containers and create a wave file, with requiring only a single set of inputs. The unique identifier may include any or all of the previously stated information for each batch of particular medicine containers.

In another embodiment for over-the-counter medicine, the software program of the central processor may contain list of various pharmaceutical products with different dosages so that an operator may click a specific product and dosage, and a specific set of OTC instructions will appear. The operator will click to confirm and this may be transmitted to the desired lots of medicine. A preexisting wave file corresponding to that selection by the operator will thus be automatically brought up and wirelessly transmitted to the medicine container microprocessors when desired and an operator sends an appropriate directive.

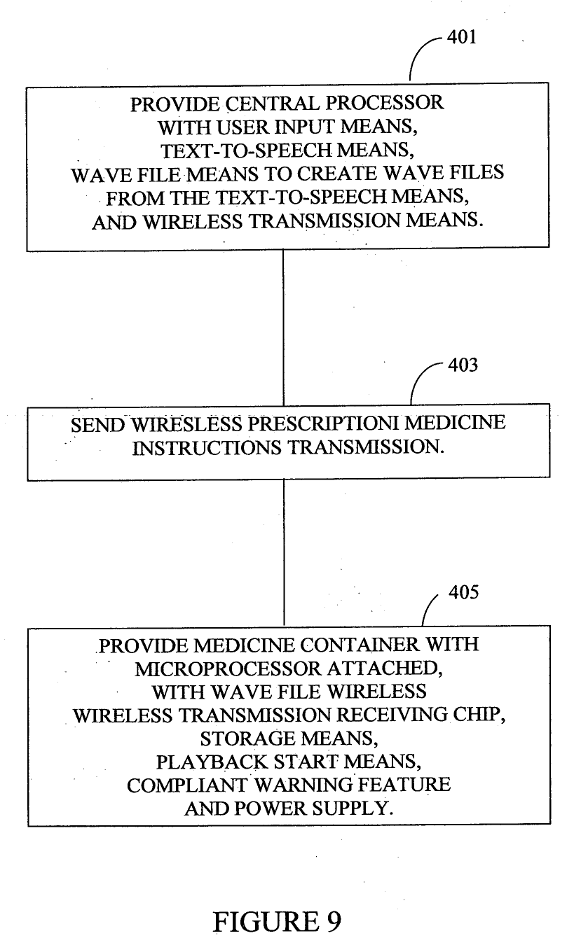

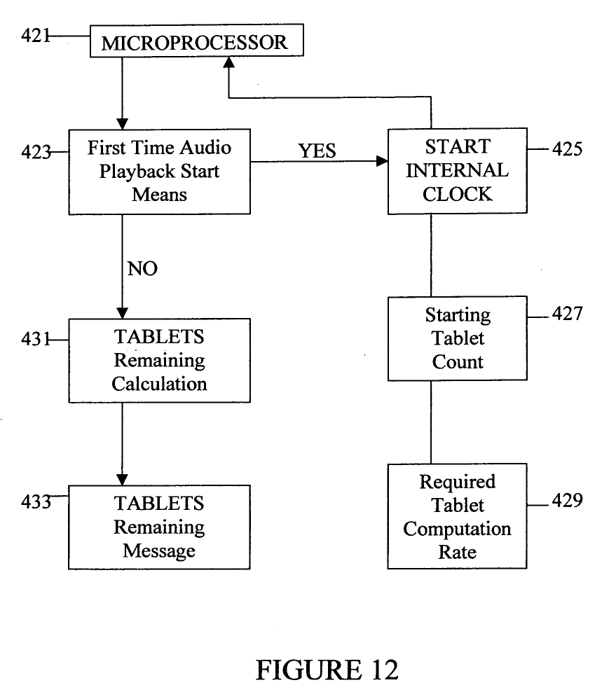

FIG. 9 illustrates a schematic diagram of one preferred embodiment of the present invention method and system for prescription medicine including a compliant warning feature. The details of the compliant warning feature are described and illustrated by FIG. 12.

Central processor 401 also includes wave file means to create wave files from the text-to-speech means, as well as wireless transmission means. Wave files creation and wireless transmission, not in the present invention system, are known to the artisan and are described in the cited prior above.

The user will use the input means to create the wave files by normal input of prescription medicine instructions, and these are wirelessly transmitted 403 to medicine container 405.

Medicine container 405 includes a microprocessor attached to it that receives the wave file wireless transmission, storage means for storing the wave file and whatever additional software that may be required to create audible speech patterns. Medicine container 405 also includes play back and play back start means as well as a power supply. In addition, the microprocessor also includes a compliant warning feature that is activated by the play back start means. Typically, the microprocessor would be located on the bottom of the medicine container and would be cylindrical or otherwise conformed to the general shape of the medicine container. Alternatively, it could have any convenient shape and be located on any aria of the medicine container or its cap. It would include a start mechanism that could be a button or switch, or its equivalent. A user would simply activate the start mechanism and the microprocessor would automatically play back the prescription instructions and the compliant warning feature.

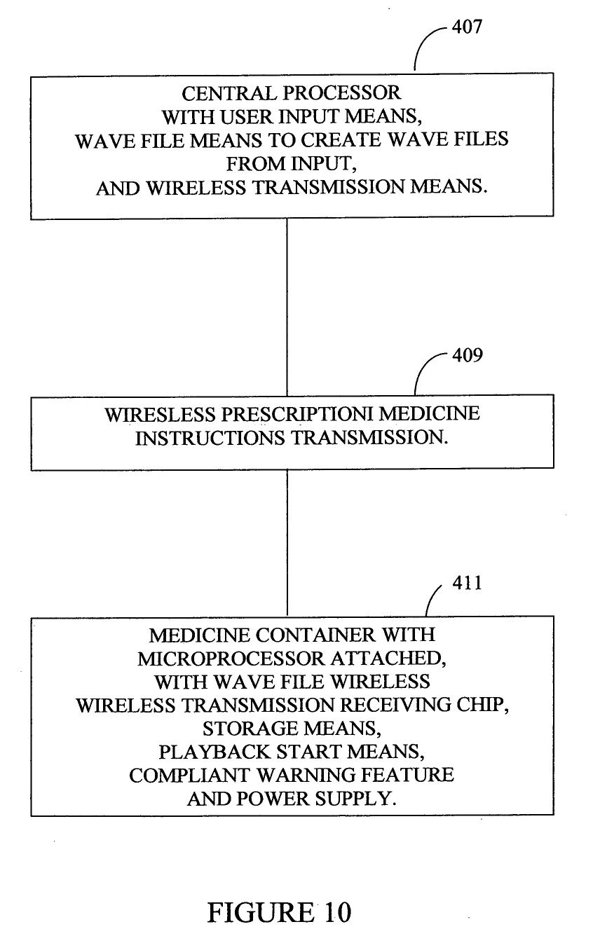

FIG. 10 shows another schematic diagram of an alternative embodiment of a present invention method and system for prescription medicine including a compliant warning feature. The details of the compliant warning feature are described and illustrated by FIG. 12.

In this embodiment, the central processor 407 functions similarity to central processor 1 above but creates wave files directly from inputs and transmits 409 these to container 411. Medicine container 411 functions similarity to medicine container 405 of FIG. 9.

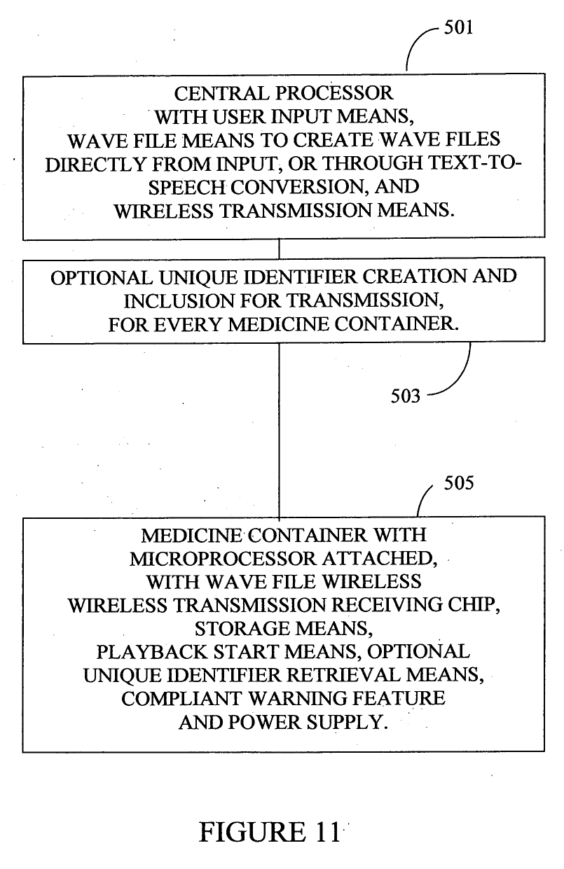

FIG. 11 illustrates another preferred embodiment of the present invention method and system for wirelessly transferring prescription medicine instructions from a central processor to a medicine container for subsequent audio playback by a user including a compliant warning feature. The details of the compliant warning feature are described and illustrated by FIG. 12.

Central processor 501 may be arranged as in FIG. 9 or as in FIG. 10 above, and, includes optional unique identifier capabilities 503. This includes sufficient equipment and software to create a unique identification code for each and every medicine container to which a wave file is sent. This code could be any combination of numbers and/or letters and/or symbols.

FIG. 12 illustrates a schematic diagram of the compliant warning feature shown in FIGS. 9, 10 and 11. A microprocessor 421 includes programming for a compliant warning feature. The microprocessor has an internal clock 425, total medicine container starting tablet count 427, required tablet consumption rate data 429. The internal clock 425 is started when a patient activates the audio playback start means 423 for a first time. The total medicine container starting tablets and required tablet consumption rate data are determined from the pharmacists records created on the wave file for patient information, including total tablets in medicine container and required tablet consumption rate.

When a user subsequently activates the audio playback start means 423 at a later time, the microprocessor programming performs a tablets should be remaining calculation 431 and plays back a regimen message 433. The regimen message advises the user that a predetermined number of tablets should be remaining in the medicine container at this time, and if that predetermined number of tablets remaining is in excess by a predetermined amount, that patient is advised to contact a professional.

For example, if the total medicine container starting tablets are twenty-four and the required tablet consumption rate is one tablet every twelve hours, after ten days from when the audio playback start means is first activated, the microprocessor computes the tablets that should be remaining to be four. If the predetermined amount is set to be greater than two more than should be remaining, then the tablets remaining message would state “please call a professional if the number of tablets remaining is greater than six.”

Obviously, numerous modifications and variations of the present invention are possible in light of the above teachings. It is therefore understood that within the scope of the appended claims, the invention may be practiced otherwise than as specifically described herein.

What is claimed is:

1. A method of communicating medicine instructions to a patient, which comprises:
(a.) providing at least one medicine container, each of said at least one medicine container including a storage area for medicine, and a microprocessor attached to each of said at least one medicine container, said microprocessor including:
(a)(i) a wave file receiving chip;
(a)(ii) a wave file storage means;
(a)(iii) a wave file audio playback means;
(a)(iv) an audio playback start means; and
(a)(v) a power supply within said microprocessor adapted to power components of said microprocessor;
(b.) providing a central processor separate from said at least one medicine container, said central processor including:
(b)(i) user input means;
(b)(ii) text-to-speech means;
(b)(iii) wave file means to create a wave file from said text-to-speech means; and
(b)(iv) wireless transmission means to wirelessly transmit said wave file from said central processor to said microprocessor wave file receiving chip;
(c.) inputting said user input means to create medicine instruction text;
(d.) converting said text to electronic speech;
(e.) creating a wave file with said electronic speech;
(f.) transmitting said wave file to said microprocessor wave file receiving chip; and
(g.) storing said wave file in said microprocessor for subsequent playback by a user by activating said audio playback starting means.

2. The method of claim 1 wherein said central processor is a computer system and said user input means is a conventional computer user input means selected from keyboard, mouse, ball and touch pad.

3. The method of claim 1 further comprising:
(h.) creating a unique identifier in said central processor;
(i.) wirelessly transmitting said unique identifier to said microprocessor; and
j.) providing accessing means for accessing said unique identifier from said microprocessor.

4. The method of claim 1 wherein said user-input means is a microphone and said central processor includes conversion means for converting speech to electronic input.

5. The method of claim 1 wherein there is one medicine container for prescription medicine and said medicine instructions are for prescription medicine.

6. The method of claim 5 wherein said microprocessor further includes a compliant warning feature which includes an internal clock, total medicine container starting tablet count, required tablet consumption rate data, and programming, wherein said internal clock is started when a patient activates said audio playback start means for a first time, and, wherein, when a user subsequently activates said audio playback start means at a later time, said microprocessor plays back a regimen message advising the user that a predetermined number of tablets should be remaining in the medicine container at this time, and if that said predetermined number of tablets remaining is in excess by a predetermined amount, that patient is advised to contact a professional, and wherein, said microprocessor calculates current tablet count based upon said first activation, said total starting tablet count, and said tablet consumption rate data.

7. The method of claim 5 wherein said central processor further includes: (a)(vi) a preset data collection of prescription medicine instructions, including for different medications and different dosages, and sufficient software to permit a user to select appropriate prescription medicine instructions corresponding to a specific medication and dosage combination.

8. The method of claim 1 wherein there is a plurality of medicine containers for over-the-counter medicine, said medicine instructions are for over-the-counter medicine and are communicated to a plurality of patients utilizing same medicine and dosage, and further comprising: (h.) providing a plurality of medicine units to said storage area of each of said plurality of medicine containers, said plurality of medicine units being the same medicine and having the same dosage for each of said plurality of medicine containers.

9. The method of claim 8 wherein said central processor further includes: (a)(vi) a preset data collection of over-the-counter medicine instructions, including for different medications and different dosages, and sufficient software to permit a user to select appropriate over-the-counter medicine instructions corresponding to a specific medication and dosage combination for a specific plurality of over-the-counter medicine containers having the same medicine units and the same dosage.

10. A method of communicating medicine instructions to a patient, which comprises:
(a.) providing at least one medicine container, said at least one medicine container including a storage area for medicine, and a microprocessor attached to each of said at least one medicine container, said processor including:
(a)(i) a wave file receiving chip;
(a)(ii) a wave file storage means;
(a)(iii) a wave file audio playback means;
(a)(iv) an audio playback start means; and
(a)(v) a power supply within said microprocessor adapted to power components of said microprocessor
(b.) providing a central processor separate from said at least one medicine container, and said central processor including:
(b)(i) user input means for inputting electronic medicine instruction input;
(b)(ii) wave file means to create a wave file from said electronic medicine input from said input means; and
(b)(iii) wireless transmission means to wirelessly transmit said wave file from said central processor to said microprocessor wave file receiving chip;
(c.) inputting medicine instructions with said user input means to create electronic input;
(d.) creating a wave file with said electronic input;
(e.) transmitting said wave file to said microprocessor wave file receiving chip;
(f.) storing said transmitted wave file wireless transmission for subsequent audio playback by a user by activating said audio playback starting means.

11. The method of claim 10 wherein said central processor is a computer system and said user input means is a conventional computer user input means selected from the group consisting of keyboard, mouse, ball and touch pad.

12. The method of claim 10 further compromising:
(g.) creating a unique identifier in said central processor;
(h.) wirelessly transmitting said unique identifier to said microprocessor; and
(i.) providing processing means for accessing said unique identifier from said microprocessor.

13. The method of claim 10 wherein there is one medicine container for prescription medicine and said medicine instructions are for prescription medicine.

14. The method of claim 13 wherein said microprocessor further includes a compliant warning feature which includes an internal clock, total medicine container starting tablet count, required tablet consumption rate data, and programming, wherein said internal clock is started when a patient activates said audio playback start means for a first time, and, wherein, when a user subsequently activates said audio playback start means at a later time, said microprocessor plays back a regimen message advising the user that a predetermined number of tablets should be remaining in the medicine container at this time, and if that said predetermined number of tablets remaining is in excess by a predetermined amount, that patient is advised to contact a professional, and wherein, said microprocessor calculates current tablet count based upon said first activation, said total starting tablet count, and said tablet consumption rate data.

15. The method of claim 13 wherein said central processor further includes: (a)(vi) a preset data collection of prescription medicine instructions, including for different medications and different dosages, and sufficient software to permit a user to select appropriate prescription medicine instructions corresponding to a specific medication and dosage combination.

16. The method of claim 10 wherein there is a plurality of medicine containers for over-the-counter medicine, said medicine instructions are for over-the-counter medicine and are communicated to a plurality of patients utilizing same medicine and dosage, and further comprising: (g.) providing a plurality of medicine units to said storage area of each of said plurality of medicine containers, said plurality of medicine units being the same medicine and having the same dosage for each of said plurality of medicine containers.

17. The method of claim 16 wherein said central processor further includes: (a)(vi) a preset data collection of over-the-counter medicine instructions, including for different medications and different dosages, and sufficient software to permit a user to select appropriate over-the-counter medicine instructions corresponding to a specific medication and dosage combination for a specific plurality of over-the-counter medicine containers having the same medicine units and the same dosage.

18. A system for communicating medicine instructions to a patient by wireless communication from a central processor to a medicine container for subsequent audio speech playback from said medicine container to a user, which comprises:
(a.) at least one medicine container, said at least one medicine container including a storage area for medicine, and a microprocessor attached to said at least one medicine container, said microprocessor including:
(a)(i) a wave file receiving chip;
(a)(ii) a wave file storage means;
(a)(iii) a wave file audio playback means;
(a)(iv) an audio playback start means; and
(a)(v) a power supply within said microprocessor, and adapted to power components of said microprocessor;
(b.) a central processor separate from said at least one medicine container, said central processor including:
(b)(i) user input means;
(b)(ii) text-to-speech means;
(b)(iii) wave file means to create a wave file from said text-to-speech means; and
(b)(iv) wireless transmission means to wirelessly transmit said wave file from said central processor to said microprocessor wave file receiving chip.

19. The system of claim 18 wherein said central processor is a computer system and said user input means is a conventional computer user input means selected from keyboard, mouse, ball and touch pad.

20. The system of claim 18 further comprising:
(c.) means for creating a unique identifier in said central processor;
(d.) means for wirelessly transmitting said unique identifier to said microprocessor; and
(e.) accessing means for accessing said unique identifier from said microprocessor.

21. The method of claim 18 wherein there is one medicine container for prescription medicine and said medicine instructions are for prescription medicine.

22. The method of claim 21 wherein said microprocessor further includes a compliant warning feature which includes an internal clock, total medicine container starting tablet count, required tablet consumption rate data, and programming, wherein said internal clock is started when a patient activates said audio playback start means for a first time, and, wherein, when a user subsequently activates said audio playback start means at a later time, said microprocessor plays back a regimen message advising the user that a predetermined number of tablets should be remaining in the medicine container at this time, and if that said predetermined number of tablets remaining is in excess by a predetermined amount, that patient is advised to contact a professional, and wherein, said microprocessor calculates current tablet count based upon said first activation, said total starting tablet count, and said tablet consumption rate data.

23. The method of claim 18 wherein there is a plurality of medicine containers for over-the-counter medicine, said medicine instructions are for over-the-counter medicine and are communicated to a plurality of patients utilizing same medicine and dosage, and further comprising (c.) providing a plurality of medicine units to said storage area of each of said plurality of medicine containers, said plurality of medicine units being the same medicine and having the same dosage for each of said plurality of medicine containers.
